(19) United States
(12) Patent Application Publication
(10) Pub. No.: US 2007/0246527 A1
(43) Pub. Date: Oct. 25, 2007

(54) Stored value card with fraud protection wrapping

(76) Inventor: Michael H. K. Tang, Monterey Park, CA (US)

Correspondence Address: CHRISTIE, PARKER & HALE, LLP, PO BOX 7068, PASADENA, CA, 91109-7068, US

(21) Appl. No.: 11/407,423

(22) Filed: Apr. 19, 2006

(51) Int. Cl. G06K 5/00; G06K 7/00

(52) U.S. Cl. 235/380; 235/486

(57) ABSTRACT

A secure and confidential card display package and a method of manufacturing the same. The secure and confidential card display package includes a card carrier, a stored value card, and a clear plastic wrapping. The card carrier is constructed of a laminated sheet of material and has a first peg aperture for insertion by a display peg. The stored value card is integrally formed with and selectively detachable along a line of weakness from the card carrier and has a masking element for masking a confidential code. The clear plastic wrapping is adapted to wrap and seal the card carrier and the stored value card therein and has a second peg aperture corresponding to the first peg aperture of the card carrier for insertion by the display peg.

### FIELD OF THE INVENTION

The present invention relates to card display packages and methods of manufacturing the same, and more particularly, to secure and confidential card display packages and methods of manufacturing the same.

### BACKGROUND

Stored value cards distributed by financial institutions and/or telephone companies are typically forwarded to retail merchants for sale to individual purchasers. These stored value cards allow the holder prepaid access to existing phone networks for making phone calls, eliminating the need to carry cash on hand. In addition, they may be used to provide authorization for the rental or purchase of goods and services, or may be used as a gift certificate granting the holder credit for various goods and services.

It has been the practice with prepaid stored value cards that a merchant purchases a stock of cards just as he would any other good, at which time he incurs a charge from the vendor for the value of the stored value card. By displaying these cards for sale in his store, the merchant exposes himself to the loss of the valuable cards through fraud and theft. Furthermore, the merchant must maintain individual inventory stocks for each different value of stored value card he wishes to sell. The merchant's working capital is restricted by the need to maintain these stocks well in advance of when the stored value cards are actually sold as retail items to individual purchasers.

To address these problems, merchants have begun to sell non-activated, or “zero balance” stored value cards which have no intrinsic value until they are activated by the merchant's magnetic, bar code, and/or radio-frequency card reader. It is now a common practice to sell such cards to purchasers with the activation taking place at the merchant counter at the time of sale.

In this manner, the merchant reduces his overhead because the value of the inactivated stored value cards is not payable to the wholesale vendor of the cards until the card itself is actually distributed by the merchant at the point of sale (“POS”).

Upon sale of a stored value card to a purchaser, the merchant encodes the stored value card with a specific balance paid for by the purchaser, and the purchaser may utilize the stored value using a confidential code provided in the card. These cards are often sold mounted in or on some sort of card carrier and/or protective/display package. These packages, however, may still be susceptible to theft and fraud due to tampering (e.g., the confidential code may be pre-accessed by a malicious person such that the purchased value of the unsuspected legitimate purchaser may be later stolen).

In order to provide a card display package with a high degree of fraud protection so that it can be readily observed if the package has been tampered with, prior art packages exist wherein a card is mounted within card display panels and then covered by a clear plastic wrapping.

In particular, as shown in FIG. 1, a prior art card carrier 20 includes at least three panels. A first panel 21 includes a first window 1 for exposing a large (or majority) portion of a first face of a stored value card to be carried by the card carrier 20. A second panel 22 is connected along a vertical direction to a side of the first panel 21. The second panel 22 includes a second window 2 and a third window 3 for exposing portions of a second face of the stored value card. In addition, the card carrier 20 includes a third panel 23 connected along a horizontal direction to a side of the second panel 22. The third panel 23 includes a peg aperture 24 for insertion by a display peg.

FIGS. 2A and 2B show an assembled prior art card display package 30 having a stored value card 26 therein. Here, the display package 30 includes the card carrier 20, a stored value card 26, and a clear plastic wrapping 32. The front and rear panels 21 and 22 of the card carrier 20 have been folded and sealed against each other to contain the stored value card 26 therein. In addition, the card carrier 20 with the stored value card 26 is wrapped and sealed in the clear plastic wrapping 32 to complete the assembled card display package 30. As shown in both FIGS. 2A and 2B, the assembled display package 30 includes a peg aperture 34 corresponding to the peg aperture 24 of the card carrier 20 for insertion by a display peg.

As can be seen above, these multi-panel prior art card display packages are difficult and expensive to produce, and do not provide for an attractive graphical display area. In addition, the packages reduce the surface area of the stored value cards useful for marketing materials and other promotional items. As such, it may be desirable, according to one embodiment of the present invention, that a card display package be provided with an attractive graphical display that allows the entire surface of the actual card to be shown and allows for simple and inexpensive production, while at the same time providing a high degree of fraud protection so that it can be readily observed if the package has been tampered with.

### SUMMARY

An aspect of the present invention provides a card display package with an attractive graphical display that allows the entire surface of the actual card to be shown and allows for simple and inexpensive production, while at the same time providing a high degree of fraud protection so that it can be readily observed if the package has been tampered with.

In an exemplary embodiment of the present invention, a secure and confidential (or fraud protecting) card display package includes a card carrier, a stored value card, and a clear plastic wrapping. The card carrier is constructed of a laminated sheet of material and has a first peg aperture for insertion by a display peg. The stored value card is integrally formed with and selectively detachable along a line of weakness from the card carrier and has a masking element for masking a confidential code. The clear plastic wrapping is adapted to wrap and seal the card carrier and the stored value card therein and has a second peg aperture corresponding to the first peg aperture of the card carrier for insertion by the display peg.

In another exemplary embodiment of the present invention, a method for packaging and fraud protecting a stored value card is provided. The method includes: laminating a plurality of materials to construct a card carrier; forming a stored value card on the laminated materials to be integrally formed with and selectively detachable along a line of weakness from the card carrier; and wrapping and sealing the card carrier and the stored value card in a clear plastic wrapping. In this embodiment, the card carrier is formed with a first peg aperture for insertion by a display peg, the stored value card is formed to have a masking element for masking a confidential code, and the clear plastic wrapping is formed with a second peg aperture corresponding to the first peg aperture of the card carrier for insertion by the display peg.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 shows a pre-assembled card carrier including at least three panels according to the prior art.

FIGS. 2A and 2B show an assembled card display package having the assembled card carrier of FIG. 1 according to the prior art.

FIGS. 3A and 3B show an assembled card display package according to an embodiment of the present invention.

FIG. 4 shows a clear plastic wrapping for the assembled card display package of FIGS. 3A and 3B.

FIG. 4A shows a clear plastic wrapping for an assembled card display package according to an alternative embodiment of the present invention.

FIG. 5 shows another view of the assembled card display package of FIGS. 3A and 3B.

FIG. 5A shows another view of an assembled card display package using the clear plastic wrapping of FIG. 4A.

FIG. 6 is a cross-sectional view of a card carrier and a stored value card of FIGS. 3A and 3B.

FIG. 7 is a block diagram of an embodiment of a method used to produce the card carrier and/or the stored value card of FIGS. 3A and 3B.

FIGS. 8A and 8B show an assembled card display package according to another embodiment of the present invention.

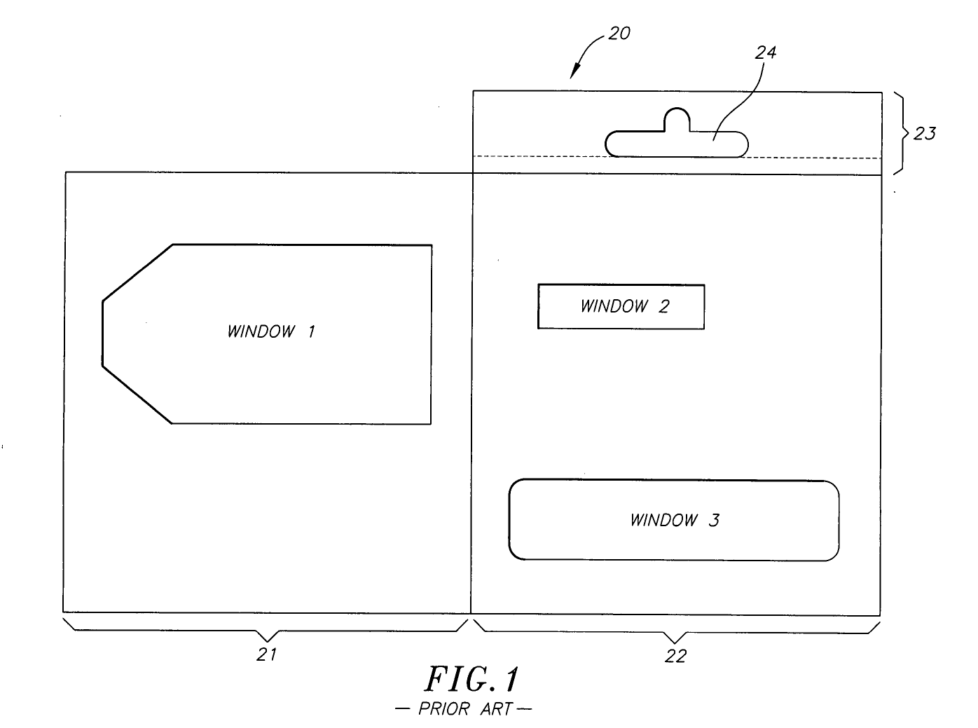

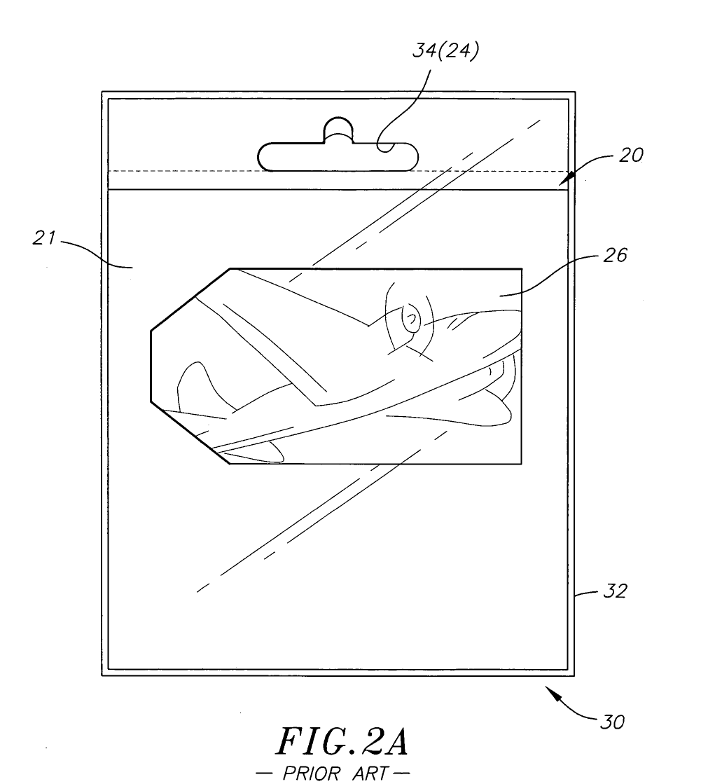

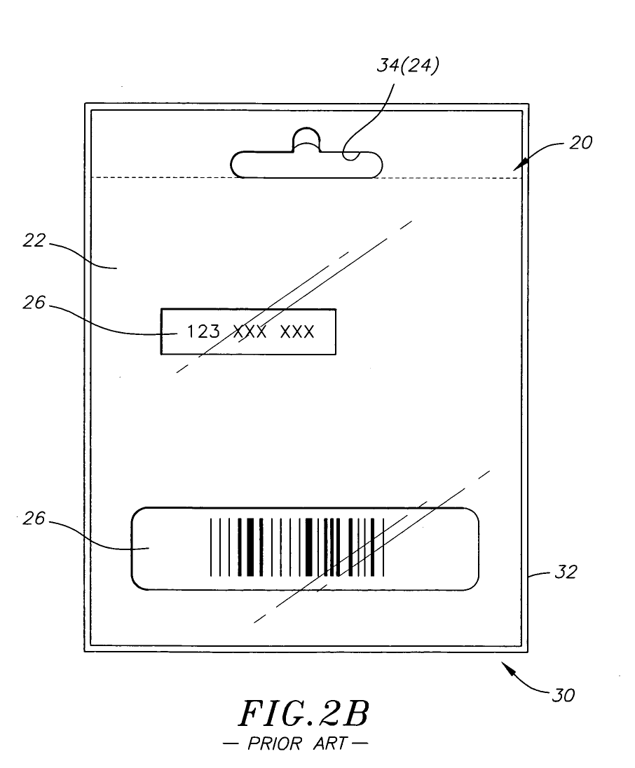

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification as they are not essential to a complete understanding of the invention. Like reference numerals designate like elements.

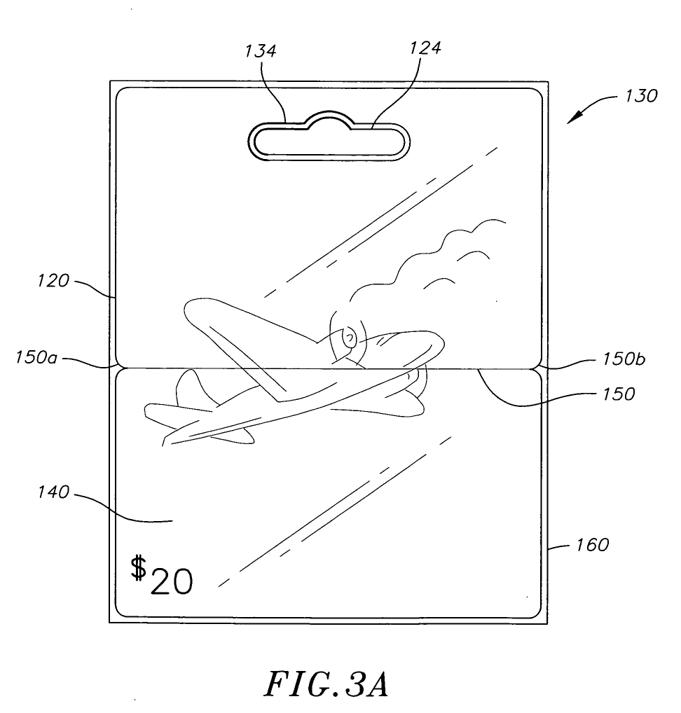

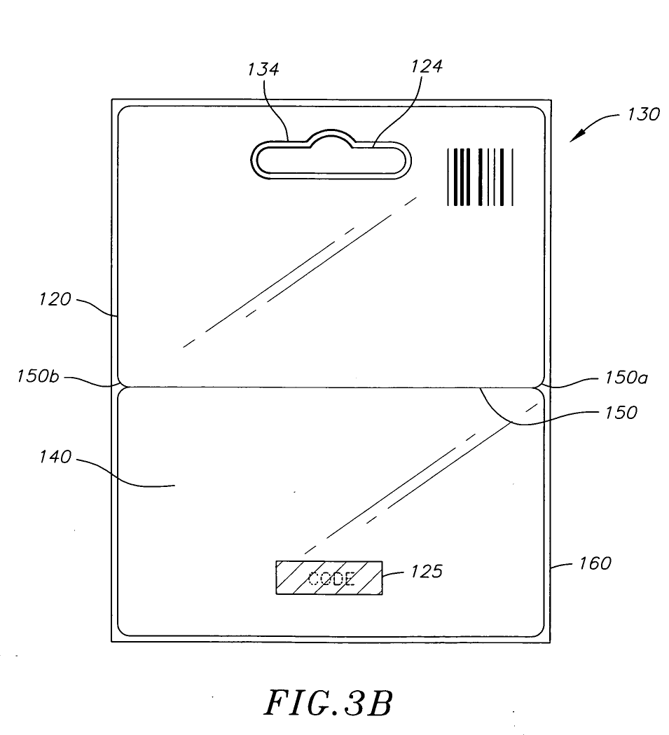

FIGS. 3A and 3B show a planar view of an assembled card display package 130 constructed in accordance with an embodiment of the present invention. The card package 130 includes a card carrier 120 and a stored value card 140, such as a phone card or a debit card. The stored value card 140 is integrally formed with and selectively detachable along a line 150 of weakness and two points 150a and 150b of weakness from the card carrier 120 such that a unitary card package is provided which is sized to be inserted into a plastic wrapping 160. The plastic wrapping 160 is sealed to complete the assembled card display package 130. Here, the card carrier 120 also includes a peg aperture 124 for insertion by a display peg.

The card carrier 120 provides a space for displaying additional information not shown in the card 140. To this end, the card carrier 120 is provided with unique advertising data which may include the establishment that is distributing the stored value card 140. The card carrier 120 may also be provided with non-variable information which may include, for example, instructional information to explain how to use the stored value card 140 and other advertising information related to the establishment that is distributing the stored value card 140.

Similarly, the stored value card 140 is provided with unique data which may include, for example, encoded information in the form of a bar code and/or a magnetic strip. The unique data on the stored value card 140 may correspond to the data on the card carrier 120. In addition, as shown in FIG. 3B, the stored value card 140 may also include a special covering and/or masking element 125 that can be selectively detachable from the stored value card 140. The covering and/or masking element 125 can be used to cover and/or mask a confidential code to prevent the confidential code from being accessed by a malicious person. In one embodiment, as shown in FIGS. 3A and 3B, the stored value card 140 is formed with a size and shape of a conventional credit-type card (and the card carrier 120 is formed with a width that is substantially the same as the stored value card 140).

Here, as shown in FIGS. 3A and 3B, the sealed clear plastic wrapping 160 wrapped around the stored value card 140 and the card carrier 120 further prevents the stored value card 140 from being tampered with by a malicious person (e.g., to prevent the confidential code from being pre-accessed by the malicious person). That is, the clear plastic wrapping 160 provides the card display package 130 with a high degree of fraud protection so that it can be readily observed if the package 130 has been tampered with. In addition, the clear plastic wrapping 160 includes a peg aperture 134 corresponding to the peg aperture 124 of the card carrier 120 for insertion by a display peg.

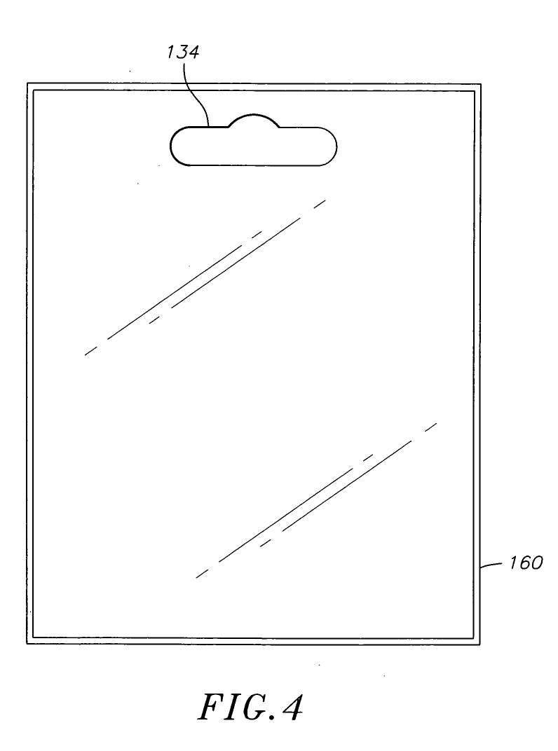

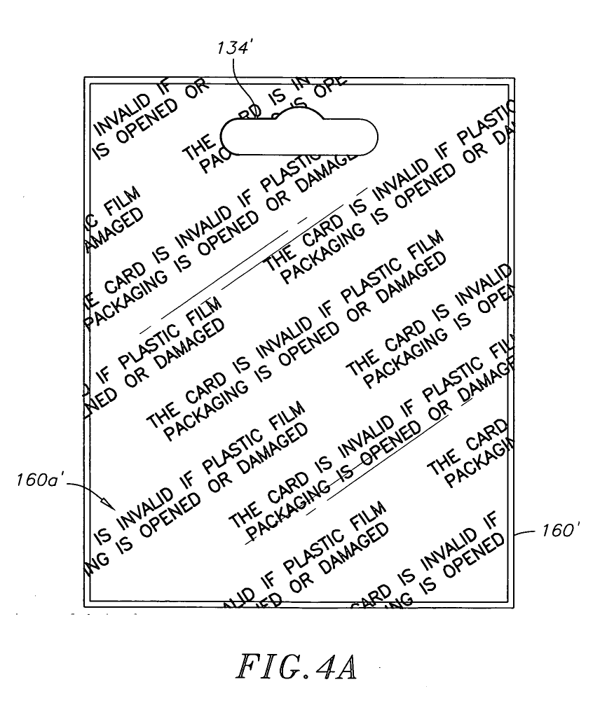

FIG. 4 illustrates the clear plastic wrapping 160 formed with the peg aperture 134 therein. The information (e.g., promotional information) disposed on the card carrier 120 and the stored value card 140 is viewable through the clear plastic wrapping 160 when the integrally formed card carrier and stored value card 120 and 140 are inserted into the clear plastic wrapping 160. By utilizing the promotional information on the card carrier 120 and the stored value card 140 and the transparency of the clear plastic wrapping 160, the processes of preparing additional information on the plastic wrapping 160 are eliminated.

Alternatively and referring now to FIG. 4A, a clear plastic wrapping 160′ according to one embodiment of the present invention is formed with a peg aperture 134′ (that is substantially the same as the peg aperture 134 of FIG. 4). In addition, the clear plastic wrapping 160′ is formed with an additional warning sign (or information) 160a′ that may be printed on the clear plastic wrapping 160′. In FIG. 4A, the warning sign 160a′ is shown to contain a statement for voiding or invaliding the stored value card (e.g., the stored value card 120), such as “THE CARD IS INVALID IF PLASTIC FILM PACKAGING IS OPENED OR DAMAGED.” This warning sign 160a′ provides an added security measure to the overall security of the assembled card display package (e.g., the assembled card display package 130).

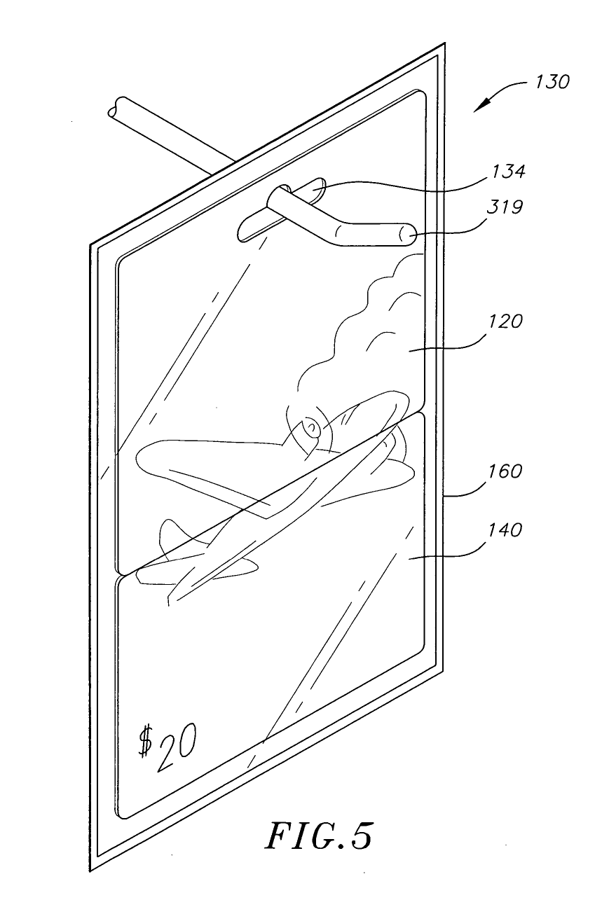

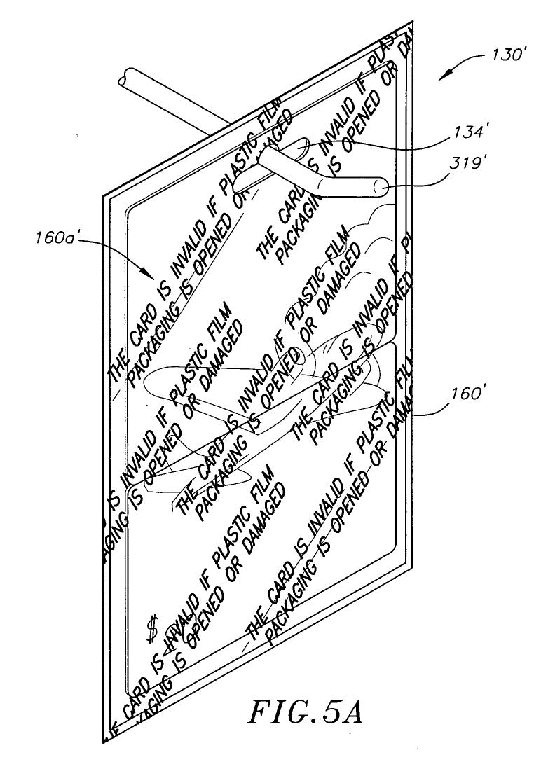

FIG. 5 shows a perspective view of the assembled card display package 130 having the stored value card 140 therein, and is shown suspended from a display peg 319 through the peg apertures 134 and 124.

FIG. 5A shows a perspective view of an assembled card display package 130′ having the additional warning sign 160a′ shown in FIG. 4A and suspended from a display peg 319′ through the peg aperture 134′ of the clear plastic wrapping 160′.

FIG. 6 is a cross-sectional view of an embodiment of the card carrier 120 and/or the stored value card 140. The embodiment of the card carrier 120 and/or the stored value card 140 is constructed of a sheet of material 612 laminated with two plastic materials 614 to produce a laminated sheet of material 610.

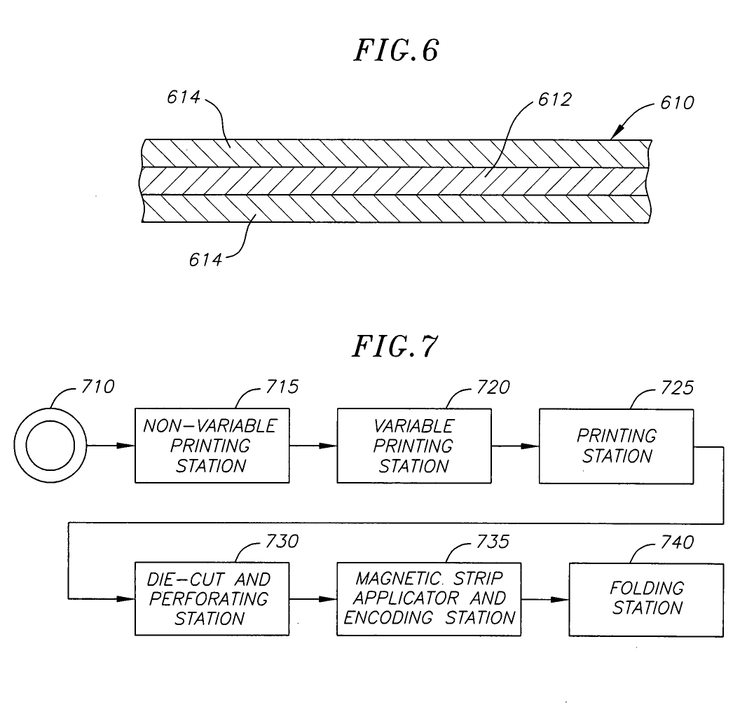

FIG. 7 is a block diagram of an embodiment of a method used to produce the card carrier 120 and/or the stored value card 140. The card carrier 120 and/or the stored value card 140 are formed by first passing a sheet of material 710 through a non-variable printing station 715 where non-variable data of the card carrier 120 and/or the stored value card 140, such as artwork, instructional information and promotional information is disposed on the sheet of material 612. This data may, in alternative embodiments, be disposed on each side of the sheet of material 612.

The sheet of material 612 is next passed through a variable printing station 720 where the unique data such as control numbers, bar codes, serial numbers, etc., are disposed on the sheet of material 612. After the unique data has been disposed on the sheet of material 612, it is passed through a laminating station 725 where each side of the sheet of material 612 is laminated with the plastic materials 614 in a manner known to one skilled in the art.

The laminated sheet of material 610 is then passed through a die cut and perforating station 730 where it is cut to the desired size. The laminated sheet of material 610 is perforated and/or weakened at certain line(s) and/or point(s) so as to define the stored value card 140 and the card carrier 120 of FIGS. 3A and 3B, as well as other portions of the card display package 130 discussed above.

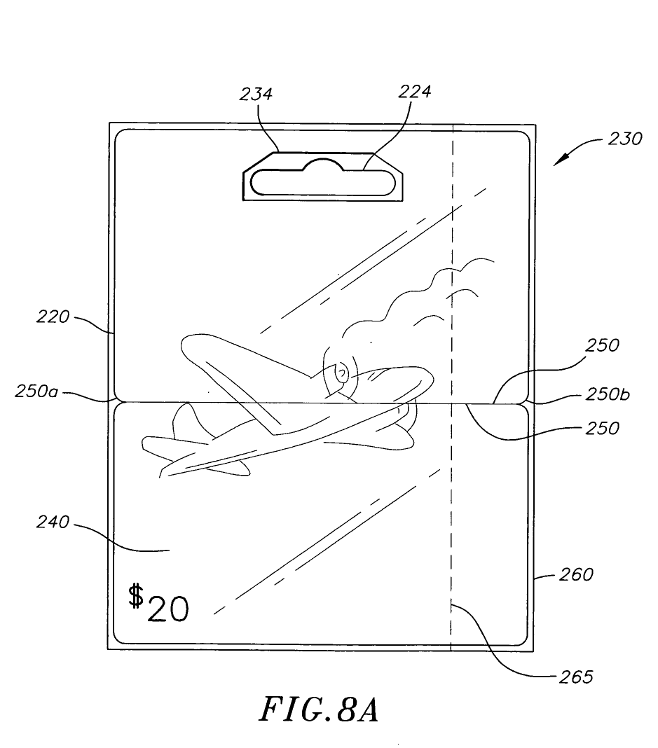

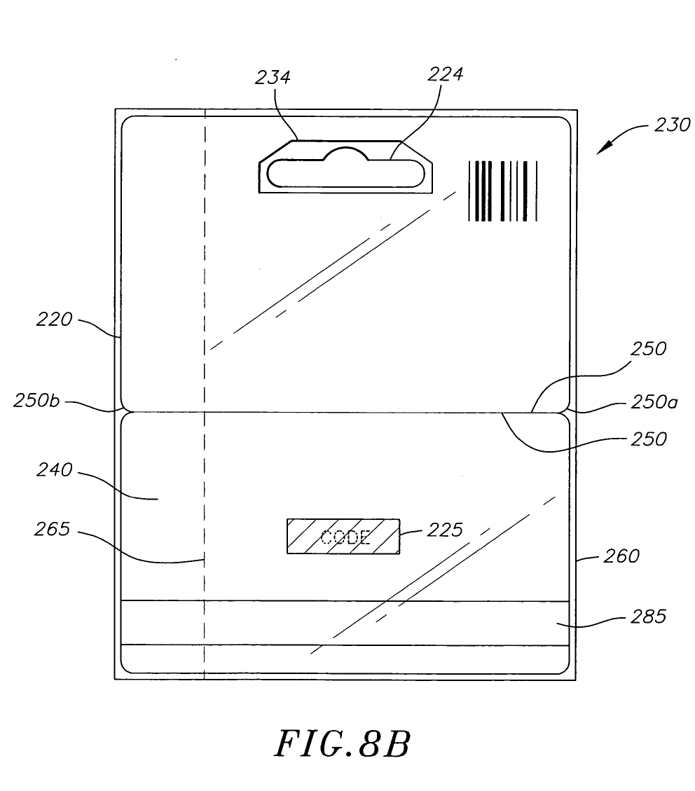

Referring to FIGS. 8A and 8B, in an alternative embodiment of the present invention, an assembled card display package 230 includes a card carrier 220 and a stored value card 240, such as a phone card or a debit card. The stored value card 240 is integrally formed with and selectively detachable along a line 250 of weakness and two points 250a and 250b of weakness from the card carrier 220 such that a unitary card package is provided which is sized to be inserted into a plastic wrapping 260. The plastic wrapping 260 is sealed to complete the assembled card display package 230. Here, the card carrier 220 also includes a peg aperture 224 for insertion by a display peg. In one embodiment, as shown in FIGS. 8A and 8B, the stored value card 240 is formed with a size and shape of a conventional credit-type card, and the card carrier 220 is formed with a width that is substantially the same as the stored value card 240.

In FIG. 8B, the stored value card 240 is shown to include a unique magnetically encodable data strip 285 which may include, for example, encoded information. In addition, the stored value card 240 may also include a special covering and/or masking element 225 that can be selectively detachable from the stored value card 240. The converting and/or masking element 225 can be used to cover and/or mask a confidential code to prevent the confidential code from being accessed by a malicious person.

Here, as shown in FIGS. 8A and 8B, the sealed clear plastic wrapping 260 wrapped around the stored value card 240 and the card carrier 220 further prevents the stored value card 240 from being tampered with by a malicious person (e.g., to prevent the confidential code from being pre-accessed by the malicious person). In addition, the clear plastic wrapping 260 includes a peg aperture 234 corresponding to the peg aperture 224 of the card carrier 220 for insertion by a display peg. Furthermore, to ease removal of the clear plastic wrapping 260 by a legitimate user, the clear plastic wrapping also includes a line of perforation 265. In FIGS. 8A and 8B, the line of perforation 285 is shown to be formed along a vertical direction of an assembled card display package 230.

The line of perforation 285 of FIGS. 8A and 8B, the line of weakness 250 of FIGS. 8A and 8B, and/or the line of weakness 150 of FIGS. 3A and 3B may have seventeen perforated holes per inch. In an alternative embodiment, The line of perforation 285 of FIGS. 8A and 8B, the line of weakness 250 of FIGS. 8A and 8B, and/or the line of weakness 150 of FIGS. 3A and 3B have two perforated holes per inch. In another alternative embodiment, the line of perforation 285 of FIGS. 8A and 8B, the line of weakness 250 of FIGS. 8A and 8B, and/or the line of weakness 150 of FIGS. 3A and 3B have a “perforation” line having a blade-to-tie ratio of 0%; i.e., the central perforation line may be simply a cut line having no perforations therein.

In view of the above and according to certain embodiments of the present invention, a card display package is provided with an attractive graphical display that allows the entire surface of the actual card to be shown and allows for simple and inexpensive production, while at the same time providing a high degree of fraud protection so that it can be readily observed if the package has been tampered with.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A fraud protecting card display package comprising:
a card carrier constructed of a laminated material, the card carrier having a first peg aperture for insertion by a display peg;
a stored value card integrally formed with and selectively detachable along a line of weakness from the card carrier, the stored value card having a masking element for masking a confidential code; and
a clear plastic wrapping adapted to wrap and seal the card carrier and the stored value card therein, the clear plastic wrapping having a second peg aperture corresponding to the first peg aperture of the card carrier for insertion by the display peg.

2. The fraud protecting card display package of claim 1, wherein the clear plastic wrapping includes a line of perforation to aid in a removal process.

3. The fraud protecting card display package of claim 1, wherein the stored value card and the card carrier are also formed with two points of weakness such that the stored value card is integrally formed with and selectively detachable along the line of weakness and the two points of weakness from the card carrier.

4. The fraud protecting card display package of claim 1, wherein the stored value card is a magnetically encodable card.

5. The fraud protecting card display package of claim 1, wherein the line of weakness is a perforated line.

6. The fraud protecting card display package of claim 1, wherein the line of weakness is a cut line having no perforations therein.

7. The fraud protecting card display package of claim 1, wherein the clear plastic wrapping includes a warning sign to provide an added security measure.

8. The fraud protecting card display package of claim 7, wherein the added security measure includes a warning for invalidating the stored value card.

9. A method for packaging and fraud-protecting a stored value card, the method comprising:
laminating a plurality of materials to construct a card carrier;
forming a stored value card on the laminated materials to be integrally formed with and selectively detachable along a line of weakness from the card carrier; and
wrapping and sealing the card carrier and the stored value card in a clear plastic wrapping,
wherein the card carrier is formed with a first peg aperture for insertion by a display peg,
wherein the stored value card is formed to have a masking element for masking a confidential code, and
wherein the clear plastic wrapping is formed with a second peg aperture corresponding to the first peg aperture of the card carrier for insertion by the display peg.

10. The method of claim 9, wherein the clear plastic wrapping is formed to include a line of perforation to aid in a removal process.

11. The method of claim 9, wherein the stored value card and the card carrier are also formed with two points of weakness such that the stored value card is integrally formed with and selectively detachable along the line of weakness and the two points of weakness from the card carrier.

12. The method of claim 9, wherein the stored value card is formed to have a magnetically encodable strip.

13. The method of claim 9, wherein the line of weakness is formed as a perforated line.

14. The method of claim 9, wherein the line of weakness is formed as a cut line having no perforations therein.

15. The method of claim 9, wherein the clear plastic wrapping is formed to include a warning sign for providing an added security measure.

16. The method of claim 15, wherein the added security measure includes providing a warning to invalidate the stored value card.
